(19) United States
(12) Patent Application Publication
(10) Pub. No.: US 2026/0080724 A1
(43) Pub. Date: Mar. 19, 2026

(54) Vehicle Power Management System and Method for Disconnecting/Resetting a Load and Using a Current Profile Based on Vehicle Information

(71) Applicant: Knorr-Bremse AG, Munich (DE)

(72) Inventors: Thomas J. Hayes, Lakewood, OH (US); Dale B. Garrett, Avon, OH (US); Peter Lindner, Rackeve (HU); David Kiss, Szar (HU); Ran Wei, North Ridgeville, OH (US); Daniel P. Zula, North Ridgeville, OH (US)

(73) Assignee: Knorr-Bremse AG, Munich (DE)

(21) Appl. No.: 18/884,986

(22) Filed: Sep. 13, 2024

(51) Int. Cl. G07C 5/04; B60R 16/033; G07C 5/00; G07C 5/08; H02J 1/14

(52) U.S. Cl. CPC G07C 5/04; B60R 16/033; G07C 5/008; G07C 5/0841; H02J 1/14

(57) ABSTRACT

A vehicle power management system and method are provided for disconnecting/resetting a load and using a current profile based on vehicle information. Each channel of the power management system can be turned off automatically to isolate a faulted load or commanded to reset a downstream device. Also, the power management system can compensate its response based on ambient temperature or other vehicle conditions. Other embodiments are provided.

### BACKGROUND

The trucking industry uses conventional fuses to protect the vehicle battery and other vehicle systems from potential damage due to load faults. Since a conventional fuse is a melting device, its time to respond to a fault is dependent on multiple factors including ambient temperatures, age, and degradation over time. Also, a conventional fuse is one-time use and non-resettable in the field.

### BRIEF DESCRIPTION OF THE DRAWINGS

FIG. 1 is a diagram of a power management system of an embodiment.

FIG. 2 is a flow chart of a method of an embodiment for disconnecting/resetting a load and using a current profile based on vehicle information.

FIG. 3 is a flow chart of a method of an embodiment for collecting vehicle information.

FIG. 4 is a flow chart of a method of an embodiment for managing a load profile database.

FIG. 5 is a flow chart of a method of an embodiment for checking for a load fault.

FIG. 6 is a flow chart of a method of an embodiment for checking for a controller fault.

FIG. 7 is a diagram of a switching circuit of an embodiment.

### SUMMARY

In one embodiment, a vehicle power management system is provided comprising: an input configured to receive current from a power source in a vehicle; one or more outputs configured to couple with a respective one or more loads of the vehicle; one or more switches associated with the respective one or more outputs, wherein each switch is respectively configured to selectively open and close to selectively provide current received from the power source to that switch's associated output; and circuitry configured to: determine if a fault condition exists for a load of the one or more loads; and in response to determining that the fault condition exists, perform a power cycle to reset the load.

In another embodiment, a method is provided that is performed in a power management system in a vehicle. The method comprises: creating a current profile for a load of the vehicle by monitoring current draws from the load and vehicle information collected when the current draws occurred; determining whether a trip current for the load should be changed based on present vehicle information; and in response to determining that the trip limit for the load should be changed, updating the current profile by updating the trip current for the load.

In yet another embodiment, a vehicle power management system is provided comprising: an input configured to receive current from a power source in a vehicle; one or more outputs configured to couple with a respective one or more loads of the vehicle; one or more switches associated with the respective one or more outputs, wherein each switch is individually configured to selectively open and close to selectively provide current received from the power source to that switch's associated output; and circuitry configured to: measure a current draw of a load of the one or more loads; collect vehicle information that exists when the current draw was measured; using the collected vehicle information, determine a trip current for the load from a current profile for the load that specifies trip currents as a function of vehicle information; determine if the measured current is greater than determined trip current; in response to determining that the measured current is greater than determined trip current, disconnect the load.

Other embodiments are possible, and each of the embodiments can be used alone or together in combination.

### DETAILED DESCRIPTION

### Overview of an Example Vehicle/Power Management System

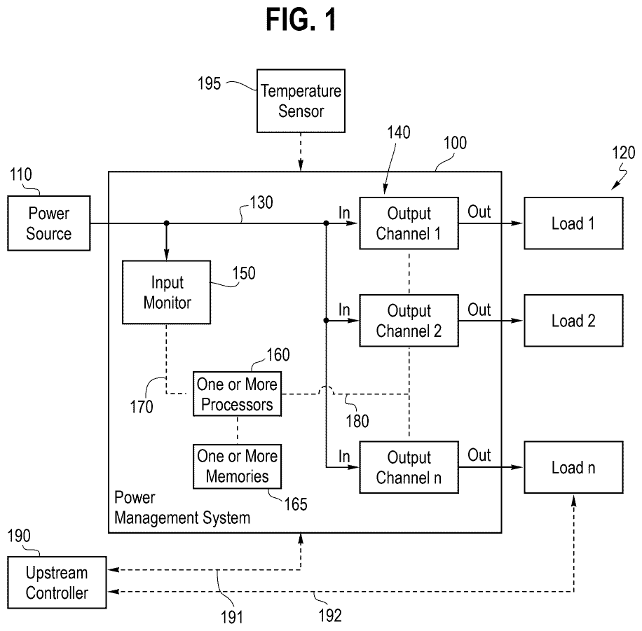

Turning now to the drawings, FIG. 1 is an illustration of an example vehicle of an embodiment. The vehicle can take any suitable form, such as, but not limited to, a truck, a tractor capable of towing a trailer, a passenger automobile, etc., and can be an electric vehicle, a vehicle with an internal combustion engine, or a hybrid vehicle. The below claims should not be limited to a specific type of vehicle unless expressly recited therein. Furthermore, the terminology used herein is intended to apply to any type of vehicle.

As shown in FIG. 1, in this embodiment, the vehicle comprises a power management system 100, a power source 110, and one or more (here, a plurality of) loads 120 (Load 1, Load 2, . . . Load N). The power source 110 can take any suitable form, such as, but not limited to, a battery, an alternator, a DC-DC converter (e.g., a 48V-to-24V or 12V converter), etc. Also, the loads 120 can take any suitable form, such as, but not limited to, a starter, vehicle sensors, pumps, compressors, braking controllers, engine controllers, a climate system (e.g., air/heat), an entertainment system (e.g., radio/audio, video, etc.), a navigation system, power seats, windshield wipers, etc. A controller is sometimes referred to herein as an electronic control unit (ECU).

The power management system 100 and the plurality of loads 120 are in communication with an upstream controller 190. While one upstream controller 190 is shown in the example of FIG. 1, it should be understood that multiple controllers on the same vehicle network communication line can be used. Also, a temperature sensor 195 (e.g., configured to sense an ambient temperature of the vehicle) is in communication with the power management system 100. Other components of the vehicle are not shown in FIG. 1 to simplify the drawing. Also, when the vehicle takes the form of a tractor-trailer, some or all of the components can be placed in the tractor and/or the trailer.

In this example, the power management system 100 comprises an input monitor 150, one or more processors 160, and one or more memories 165, and one or more (here, a plurality of) output channels 140 (Output Channel 1, Output Channel 2, . . . Output Channel n). In another embodiment, a single output channel is used. The input monitor 150 and the plurality of output channels 140 are coupled with the power source 110 via a power line 130, and the input monitor 150 and the plurality of output channels 140 are respectively coupled with the one or more processors 160 via (wired or wireless) electrical connections 170 and 180, which, in one embodiment, are communication channels (e.g., a communications area network (CAN) channel or a direct, point-to-point communication channel, such as a universal asynchronous receiver-transmitter (UART) link. In another embodiment, the electrical connections 170 and 180 are direct electrical connections that transmit analog or digital voltage. Also, while CAN is used in this example, it should be understood that any kind of communication method for the vehicle (e.g., CAN, Ethernet, PLC, WiFi, etc.) can be used.

The input monitor 150 can take the form of a sensor that is configured to read the power (or voltage or current) on the power line 130 from the power source 110. Other types of sensors that detect other types of conditions can be used.

The one or more processors 160 are configured to execute computer-readable program code having instructions (e.g., modules, routines, sub-routine, programs, applications, etc.) that, when executed by the one or more processors, individually or in combination, cause the one or more processors to perform the functions described herein (and, optionally, other functions). The computer-readable program code can be stored in the one or more non-transitory computer-readable storage medium (memories) 165, such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof. Alternatively, a purely-hardware implementation (e.g., an application-specific integrated circuit (ASIC)) can be used. The term “circuitry” will be used herein to broadly refer to any appropriate decision-making device, such as, but not limited to, a processor, a microprocessor, an ASIC, an analog circuit, etc.

In this embodiment, each output channel comprises a solid-state switch (or relay) that is configured to selectively open and close to disconnect and connect, respectively, the power source 110 from/to the output channel's load in response to a control signal provided by the one or more processors 160 via communication channel 180. Such as switch is sometimes referred to herein as a “smart fuse,” which is different from a conventional mechanical-contactor or thermal-melting fuse that automatically opens in the event of fault. A more-detailed example of one specific implementation of an output channel is provided later in this document.

### Overview of an Example Vehicle Power Management System

In one embodiment, each channel of the power management system 100 can be turned off automatically to isolate a faulted load or commanded to reset a downstream device. Also, the power management system 100 can compensate its response based on ambient temperature or other vehicle conditions. These embodiments will be described in more detail below.

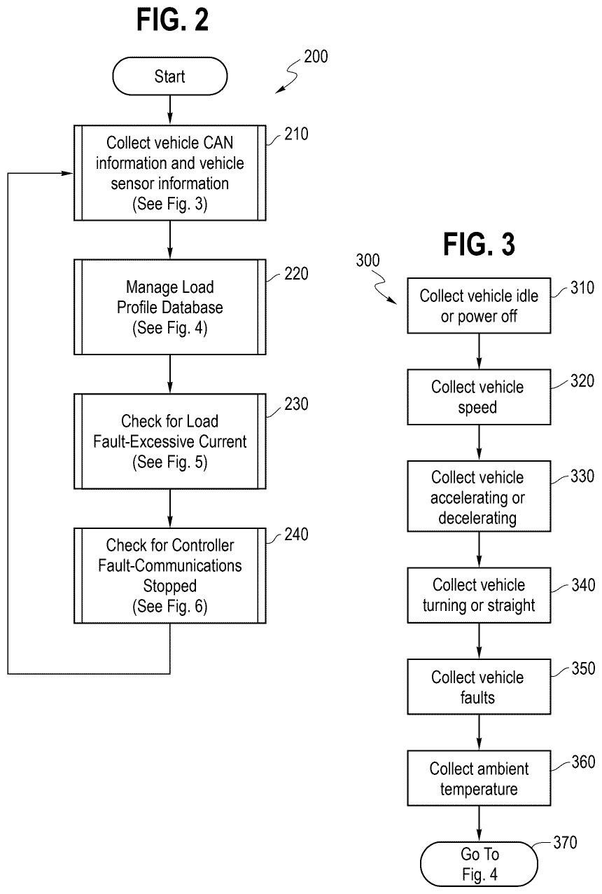

Turning now to the flow chart 200 in FIG. 2, in one embodiment, the power management system 100 collects vehicle controller area network (CAN) information (other types of networks can be used) and vehicle sensor information (210), manages a load profile database (220), checks for a load fault-excessive current (230), and checks for a controller fault or if communications have stopped (240). Each of these steps will be described in more detail in FIGS. 3-6, respectively. It should be noted that the embodiments described in FIGS. 3-6 can be used together or separately. Accordingly, the flow chart 200 in FIG. 2 reflects the situation in which all embodiments are used together, but it should be understood that each embodiment can be used separately.

Turning now to the flow chart 300 in FIG. 3, this flow chart 300 relates to the method of collecting vehicle CAN information and vehicle sensor information (step 210 in FIG. 2). “Collecting vehicle CAN information and vehicle sensor information” refers to the process of gathering one or more pieces of vehicle information either directly from a sensor (“collecting vehicle sensor information”) or indirectly via a network (“collecting vehicle CAN information”). As shown in FIG. 3, the pieces of vehicle information collected in this example are whether the vehicle is in idle/power-off mode (310), the vehicle speed (320), whether the vehicle is accelerating or decelerating (330), whether the vehicle is turning or moving straight (340), vehicle faults (350), and ambient temperature (e.g., as detected by the temperature sensor 195 in FIG. 1) (360). It should be understood that these pieces of vehicle information are merely examples and that other pieces of vehicle information can be gathered. Also, not all of the pieces of vehicle information described in FIG. 3 need to be gathered.

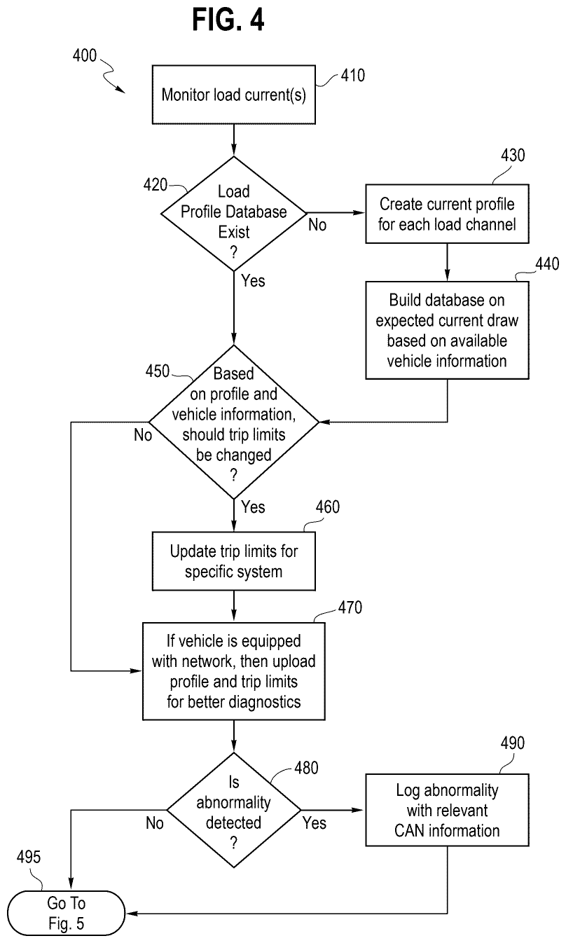

FIG. 4 is a flow chart 400 of a method for managing a load profile database (step 220 in FIG. 2). As used herein, a load profile broadly refers to information about a current or power draw by the load and can specify, for example, an amplitude, a duration, and a steady-state value. Some or all of these values can define a “trip current,” such that current or power is be removed from the load if the actual value of the current draw is greater than the specified value in the profile. Also, the load profile can comprise a plurality of trip currents for a respective plurality of vehicle information (i.e., a trip current can be a function of vehicle information (e.g., ambient temperature)).

As shown in FIG. 4, the power management system 100 monitors load current(s) (410) and determines if a load profile database exists (420). If the database does not exist, the power management system 100 creates a current profile for each load channel (430) and builds a database on expected current draw based on available vehicle information (440). After the database is built or if the database already exists, the power management system 100 determines whether a trip limit should be changed based on the profile and vehicle information (450). If it should, the power management system 100 updates the trip limits for the specific system (460). Then, or if the trip limit did not need to be changed, the power management system 100 uploads the profile and trip limits for better diagnostics, if the vehicle is equipped with a network (470). The power management system 100 then determines if an abnormality is detected (480) and, if it is, logs the abnormality with relevant vehicle information from the CAN (490).

So, this method generally performs the following acts: creating a current profile for a load of the vehicle by monitoring current draws from the load and vehicle information collected when the current draws occurred; determining whether a trip current for the load should be changed based on present vehicle information; and in response to determining that the trip limit for the load should be changed, updating the current profile by updating the trip current for the load. The updated trip current and other profile information can be stored in a data structure, such as a table or database.

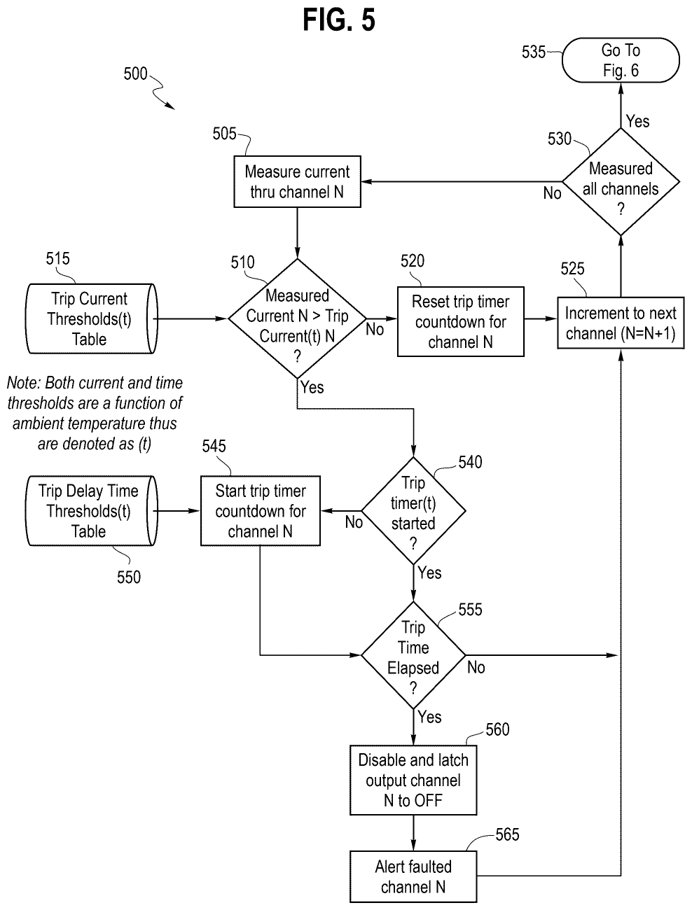

The generated load profile can be used to determine if a fault condition exists and, therefore, if the power management system 100 should disconnect the load. This is described in the flow chart 500 in FIG. 5 (step 230 in FIG. 2). As shown in FIG. 5, in this method, the power management system 100 measures current through channel N (505) and determines if the measured current is greater than a trip current received from a trip current threshold table (510, 515). If the measured current is not greater than the trip current, the power management system 100 resets the trip timer countdown for channel N (520), increments to the next channel (525), and measures that current if all the channels have not been measured (530). If the measured current is greater than the trip current, the power management system 100 determines if a trip timer is started (540). If the trip timer is started, the power management system 100 determines if the trip time has elapsed (555). If the trip time has elapsed, the power management system 100 disables and latches output channel N to off (560), alerts the faulted channel N (565), and loops to step 525. If the trip time has not elapsed, the method loops to step 525. Returning to act 540, if the trip timer has not started, the power management system 100 starts the trip timer countdown for channel N using information from a trip delay time threshold table (545, 550), after which the method proceeds to step 555.

In one embodiment, trip time can depend on the measured current. For example, if the measured current is five times the trip current, the trip time can be 1t. However, if the measured current is just two times the trip current, the trip time can be 3t.

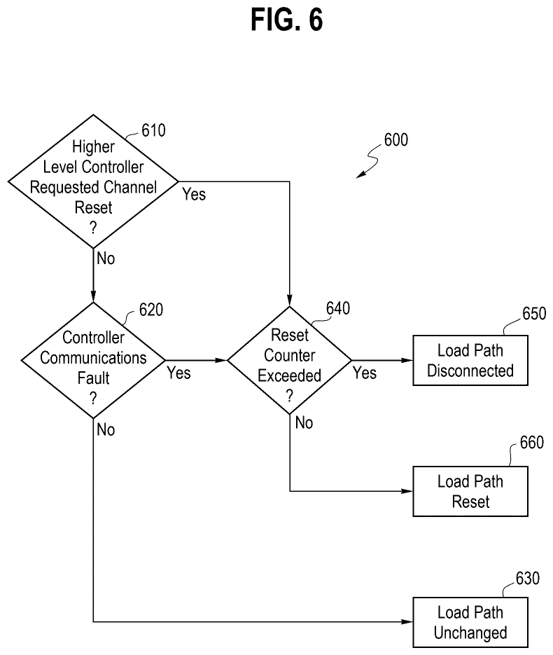

In another embodiment, the power management system 100 can disconnect or reset a load if a fault/communication failure is detected (step 240 in FIG. 2). FIG. 6 provides a flow chart 600 that illustrates this embodiment. It should be noted that while the flow chart 600 shows various acts, not all of these acts need to be used in various implementations. In FIG. 6, the power management system 100 determines if a higher-level controller (e.g., the upstream controller 190 in FIG. 1) requested a channel reset (610). This can occur, for example, with the upstream controller 190 does not receive an expected communication from a controller associated with the load, which can indicate a communication failure with that controller/load. Instead of or in addition to this trigger, a fault condition can be detected by a communication failure between the vehicle power management system 100 and the controller associated with the load (620).

In a fault/communication failure is detected, the power management system 100 determines if a reset counter was exceeded (640). If the reset counter was exceeded, the power management system 100 disconnects the load path (650). If the reset counter was not exceeded, the power management system 100 performs a power cycle to reset the load, which can solve the fault condition in some circumstances (660). However, if the higher-level controller did not request a channel reset and if there is not a controller communications fault, the load path is left unchanged (630).

### Output Channel Example

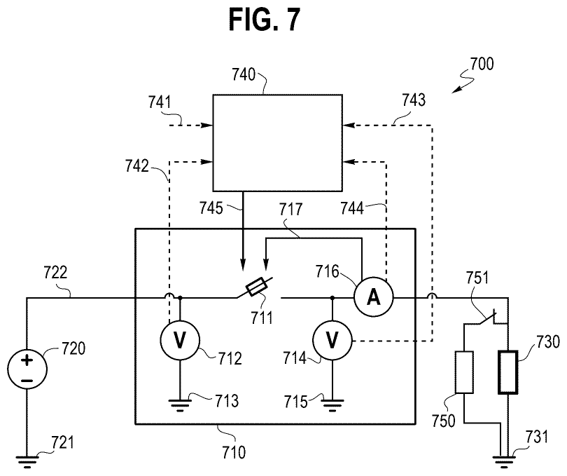

FIG. 7 and the following paragraphs illustrate one example implementation of an output channel of the power management system 100. It should be understood that this is merely one example and that other implementations can be used. Also, various components of the power management system 100 from FIG. 1 are not shown in FIG. 7 to simplify the illustration.

As shown in the diagram 700 in FIG. 7, the output channel 710 is located between a power electrical source 720 grounded by ground 721 and a load (consumer) 730 grounded by ground 731. The power source 720 is configured to supply electric power to the load 730 via a power supply line 722. The output channel 710 acts as a switching unit disposed in the power supply line 722 to connect and disconnect the load 730 to and from the power source 720.

In the exemplary embodiment, the output channel 710 comprises a switch 711 to be opened or closed to connect and disconnect the load 730 to and from the power source 720. The output channel 710 further comprises two voltage measurement units 712, 714, each of which is ground by a respective ground 713, 715. However, in alternative embodiments, the system may comprise a common ground instead of separate grounds. Accordingly, any ground 713, 715, 721, 731 shown in the present embodiment may be alternatively provided by a common ground for all components or at least groups of components to be grounded. In a direction from the power source 720 to the load 730, one voltage measurement unit 712 is connected to the power supply line 722 upstream of the switch 711, and the other voltage measurement unit 714 is connected to the power supply line 722 downstream of the switch 711. In the same direction, the output channel 710 comprises a current measurement unit 716 downstream of the switch 711 (in the given exemplary embodiment downstream of the other voltage measurement unit 714).

The voltage measurement units 712, 714 provide a signal representative of the respective instantaneous voltage to a control unit 740 to control the switch 711 in dependence of set software limits. Specifically, the one voltage measurement unit 712 provides such signal via an upstream voltage signal line 742, and the other voltage measurement unit 714 provides such signal via a downstream voltage signal line 743. In the exemplary embodiment, the control unit 740 is separate from the output channel 710. However, in other embodiments, the control unit 740 may be also comprised by the output channel 710. Similarly, the current measurement unit 716 provides a signal representative of the instantaneous current via a current signal line 744 to the control unit 740. However, a signal representative of the instantaneous current is also forwarded from the current measurement unit 716 via a switching line 717 of the output channel 710 to control the switch 711 as per a set hardware current limit.

According to the above, the switch 711 is controlled in accordance with set software limits by the control unit 740 and a set hardware limit by the switching unit. In the control unit 740, the software limits are a software voltage limit and a software current limit representative of an overvoltage and overcurrent, respectively, to protect the consumer against a respective damage. A limit can also be placed on undervoltage. The setting of the software limits is executed via a command signal line 741, which is also capable of transmitting other control commands next to setting commands. The control commands may for example comprise the opening or closing of the switch 711 for other reasons than due to software limits. The control device is configured to compare the received voltage and current signals with the set software voltage limit and the set software current limit. Further, the control unit 740 is configured to consider a time condition in the event of the software voltage limit or the software current level is exceeded by one of the respectively received signals by the voltage measurement units 712, 714 and the current measurement unit 716. For example, a signal to open the switch 711 in response to an overcurrent to be transmitted via a switching line 745 of the control unit 740 is only transmitted after the instantaneous current exceeding the software current limit is detected over a predetermined period of time. Accordingly, short tolerable peaks in voltage and current may be acceptable to avoid a frequent switching. However, in other embodiments, a time condition may not be applied to the software current limit and/or the software voltage limit. The control device is further configured to transmit a signal to the output channel 710 to reopen the switch 711 after the instantaneous current signal and voltage signal fall again below the respective software limits, which may be also linked to a time condition.

As the output channel 710 and the switch 711, respectively, may provide a sensitivity to electric current different from the load 730 or should be independent thereof, the output channel 710 as such also controls the switch 711 in accordance with a hardware limit. Further, the control in accordance with the hardware limit allows the switch 711 to be opened immediately after a critical overload occurs with any further time conditions or the like. The hardware limit is also capable of protecting at least the switching unit, if the control unit 740 fails. The system further comprises a discharge device 750 connected in parallel to the load 730. Consequently, the discharge device 750 is connected to the power supply line 722 between the output channel 710 and the load 730 and to the ground 731. The discharge device 750 is configured to remove residual charges stored in the input capacitors of the load 730 when the load 730 is not supplied with electric power from the power source 720. Thus, a faster switch off of the load 730 may be achieved and an unwanted charging up of the capacitors may be prevented.

More information about embodiments that can be used for a vehicle switching unit can be found in PCT Publication No. WO 2023/213488, which is hereby incorporated by reference.

### Additional Embodiments

Embodiments that can be used alone or in combination with any of the above embodiments are described in “Vehicle Power Management System and Method for Creating and Using a Current Draw Profile to Assess Whether a Load Is an Authorized Part,” U.S. Patent Application No. ______ (attorney docket no. 123687.PI041US (2024P00033 US)), which is being filed herewith and is hereby incorporated by reference herein.

The following paragraphs describe additional embodiments that can be used alone or in combination with any of these embodiments. Some of these additional embodiments elaborate on some of the embodiments described above.

### Shutoff of Electrical Loads (Internal)

There are power management systems outside the automotive industry that can cut-off or disconnect loads that draw excessive current during a load failure. The purpose of these systems and disconnecting devices is to isolate and contain the fault to prevent propagation to other components and potentially risk the integrity of the overall electrical system. In one embodiment, during abnormal conditions, an intelligent power management system, such as the one described above, can detect and isolate downstream loads when they experience a failure (e.g., shorted, overheated, locked-rotor). The intelligent power management system can improve overall system efficiency and minimize voltage sag during normal operation by limiting in-rush current to loads that require a high starting current.

Currently, the trucking industry uses conventional fuses to protect the vehicle battery and other vehicle systems from potential damage due to load faults. Since a conventional fuse is a melting device, its time to respond to a fault is dependent on multiple factors including ambient temperatures, age, and degradation over time. This inconsistent response to load failures can inflict incidental damage to other vehicle components. As a result, OEMs can experience higher material and labor cost to replace batteries, fuses, and other parts due to variable fusing behavior. The intelligent power management system of this embodiment avoids this by using smart fuses, smart monitoring, and a smart algorithm to determine if the load is working in the correct state, thereby controlling the corresponding connection to the load. Also, a conventional fuse is one-time use and non-resettable in the field. Depending on the scenario, an intelligent power management system may attempt to reset a faulted load in order to self-recover and minimize downtime. The intelligent power management system can monitor each individual load channel and compare it against previously collected data. This data collection generates a baseline power consumption for each load (depending on the type of load (e.g., a brake system, engine, autonomous driving system, etc.)).

In one embodiment, the intelligent power management system is equipped with a neural processing unit (NPU) with ambient environment awareness sensors (such as a temperature sensor, an altitude sensor, etc.). This intelligent power management system not only collects data and compares it with a baseline, but it also learns from the collected data and understands the acceptable power waveform the subsystem should be in at certain environmental conditions. For example, a brake system power waveform can be different when there is no braking, moderate braking, and ABS braking. Under different environments, these can vary as well. With this feature, the intelligent power management system can detect the early fatigue of the load system.

If an unexpected power profile is monitored by the intelligent power management system, the event can be recorded and that load channel can be disconnected to protect the rest of the vehicle. The system can report the failure to the driver or vehicle owner from the system database and act accordingly, such as by replacing components or conducting preventative maintenance. In autonomous applications, a battery can also be considered a downstream load. The intelligent power management system can similarly monitor the battery current and provide a redundant layer of protection in the event of a battery failure. The benefits of the system are to isolate downstream component failures to improve the ability to safely complete a vehicle's mission. Unlike fuses, the intelligent power management system has the ability to continually monitor downstream loads, fault conditions, and potentially self-recover. Therefore, the system can continue to reconnect to a once-faulted load.

### Shutoff of Electrical Loads (External Communication)

Intelligent power distribution modules exist that measure current and voltage for electrical loads on vehicles for road and off-road applications. Some of these modules contain fuses, and others contain disconnect switches to isolate and contain the fault with the goal of preventing propagation to other components and potentially risking the integrity of the overall electrical system. A vehicle can operate in various states including power off, idle, acceleration, and deceleration over the course of a mission.

These states can also be electric vehicle (EV) operating systems, such as, but not limited to, charging, regeneration, propulsion, etc. In each state, the total power consumption is different. Smart switch shutoff operation(s) within an intelligent power distribution module can selectively de-energize targeted loads or all loads automatically based on inferred vehicle conditions or based on inferences about vehicle conditions derived from the vehicle's communication network. For example, when the vehicle is powered off, the intelligent power management system can ensure that downstream loads are properly disconnected to protect the vehicle's main battery. Another benefit is that the system may monitor for CAN error frames, message timeouts, or error messages and perform power resets on these systems in an attempt to restore working conditions of these devices without the need to interrupt the vehicle's mission.

As mentioned above, the current trucking industry uses conventional fuses to protect the battery and other vehicle systems from potential damage. Melting fuses are designed to respond to a high-current condition usually in the event of a component failure. Conversely, there may be vehicle operating conditions where the downstream loads are operating normally but may need to be disconnected for the integrity of the overall vehicle and mission. Conventional fuses do not have this level of granular control. Automatic or prescribed isolation of system loads with potential, predicted, observed, or historical energy anomalies may comprise nuisances, threats or hazards within the vehicle's power net while maintaining the opportunity to trial powerup of suspect loads based on vehicle conditions. In addition, many older or less-sophisticated controllers may lack internal supervisory circuits that can reset in the system in the event of abnormalities. The power module of this embodiment can serve the need of these supervisory systems, making these controllers (e.g., ECUs) safer. While the intelligent power management system is actively monitoring each individual load channel, it can also communicate to the other vehicle systems. This allows the vehicle to have granular control of normally operating loads based on certain driving conditions.

For example, in autonomous applications, the intelligent power management system can report the battery condition and profile of all loads to a higher-level system controller. The system controller can then extrapolate remaining mileage and advise the Advance Driver Assistance System (ADAS) if the trip needs to be re-routed or, in worse conditions, shed non-critical loads to conserve energy and complete the mission. It may also determine the state of autonomy of the vehicle and shut down specific loads that are not needed at the current state.

The benefits of the system are to respond to upstream vehicle conditions to improve the ability to safely complete a vehicle's mission. When the vehicle is powered off, the intelligent power management system can enter a low-power, sleep state, only waking periodically to monitor loads intermittently. This can avoid excessive drain on the battery while powered-off.

During a minimum risk maneuver initiated by the previously mentioned higher-level system controller, the intelligent power management system can be commanded to shed non-critical loads to conserve energy. If a system is believed to be malfunctioning, the monitoring system can read the CAN messages originating from the suspect system along with the corresponding current consumption. If the CAN messages originating from the suspect system have errors and/or the current draw of the system does not correlate to the actions requested by the vehicle, external brake request (XBR), or human braking request, the supervisory system can reset the controller in an attempt to recover it back to a functioning status. If this reset does not work, it can shut the system down and report that the vehicle needs servicing. Lastly, in the event of a vehicle rollover, the higher-level system controller can command the intelligent power management system to completely disconnect and isolate the entire downstream electrical system to minimize risk to safety personnel and first responders.

### Learning a Current Draw Profile After Nominal Vehicle Use

As mentioned above, the power management system can be made aware of the expected current draw by being provided with an expected current profile and/or the power management system can be configured to learn the expected current profile. For example, the power management system can be configured to learn the expected current profile after nominal vehicle use. In one example implementation, the power management system creates a current profile for a load of the vehicle by monitoring current draws from the load and conditions of the vehicle when the current draws occurred, monitors a current draw from a replacement load, determines if the monitored current draw of the replacement load matches the current profile, and in response to determining that the monitored current draw does not match the current profile, flags the replacement load as being unauthorized.

Vehicles equipped with a current and power distribution system can closely monitor the current drawn by the systems it supports. Using this monitoring and knowledge of the vehicle state, battery voltage, operating environment, vehicle pressure, etc., a highly-defined current profile can be created for every system attached to the power distribution system. This profile can then be shared to other vehicles (e.g., if those vehicles are connected to a cloud server). As this profile is created, the trip currents for the support system may become dynamic and can be changed depending on the vehicle's operating environment. It may also be determined that a current supply with a lower power rating can be used for that specific system.

The data gathered during the lifetime of the electrical load can be used to optimize the next generation of such electrical loads either by changing the hardware or just by updating the software. For example, at low temperatures, the inrush current of one of the loads can have a significant impact on the battery life, and the next generation can include a pre-charge circuit that can increase the battery lifetime. Depending on the environment of operation of an electrical or mechatronic device, the current draw of the equipment can change. Due to every vehicle operating in a very different environment and using the equipment in a different manner, each power distribution module can create a custom current profile for each vehicle. It can also map these profiles to drivers and routes to determine if excessive use is occurring on these routes or by these drivers, adding in better planning to ensure parts last longer. Using a smart current profile along with a smart current disconnect (as opposed to traditional melting fuses) can allow for better protection and less driver nuisance for melting fuses not performing correctly. The power distribution and monitoring system can have a connection to the vehicle CAN to receive information on the vehicle state, such as pressures, temperatures, speeds, and actions exercised on the monitored device. The system can also correlate the actions of the monitored systems to the reactions from the vehicle, such as the change of an “AIR1” message in relation to the activation of pneumatic valves, showing a correct drop in pressure supply if the compressor is turned off. All of these reactions can create a datapoint to refer to in a future case if the J1939 “AIR1” pressure reaction changes compared to a known action. This monitoring system can also allow for better diagnostics of a certain part. For example, it can determine if a part was faulty at a certain extreme temperature but is working fine when at an ambient temperature, or if the current draw is correct but the resulting change in air pressure is different. This can result in fewer parts returned with no faults found during investigation, thus reducing inconvenient for the fleet manager. While the vehicle is in an operating state, the power distribution and monitoring system can monitor the current draw from its monitored systems and compare it with CAN information it receives from the vehicle network. For all types of different operating environments, the system can build a database for the current draw of that system in those specific conditions and any reactions from the vehicle (e.g., air pressure changes, voltage changes, etc.). It can continue to build this database for the life of the parts it is monitoring, alerting a fleet manager of any deviations, along with the operating conditions present when the deviation occurred. As the database of current profiles is created and updated, the monitoring system can update trip or protection currents as it knows more about the system, including dynamic changes based on the vehicle operating environment, temperatures, and system voltage. If the part is replaced after use, it can determine if the new part is aging the same way.

### Conclusion

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A vehicle power management system comprising:
an input configured to receive current from a power source in a vehicle;
one or more outputs configured to couple with a respective one or more loads of the vehicle;
one or more switches associated with the respective one or more outputs, wherein each switch is configured to selectively open and close to selectively provide current received from the power source to that switch's associated output; and
circuitry configured to:
determine if a fault condition exists for a load of the one or more loads; and
in response to determining that the fault condition exists, perform a power cycle to reset the load by selectively opening and closing the respective switch.

2. The vehicle power management system of claim 1, wherein the circuitry is further configured to:
determine if a reset counter is exceeded, wherein the power cycle is performed only if the reset counter is not exceeded.

3. The vehicle power management system of claim 2, wherein the circuitry is further configured to:
disconnect the load in response to the reset counter being exceeded.

4. The vehicle power management system of claim 1, wherein determining if the fault condition exists comprises determining whether a reset request was received from a first controller that is in communication with a second controller associated with the load, wherein the reset request is sent by the first controller to the vehicle power management system in response to the first controller detecting a communication failure with the second controller.

5. The vehicle power management system of claim 1, wherein determining if the fault condition exists comprises detecting a communication failure between the vehicle power management system and a controller associated with the load.

6. A method comprising:
performing in a power management system in a vehicle:
creating a current profile for a load of the vehicle by monitoring current draws from the load and vehicle information collected when the current draws occurred;
determining whether a trip current for the load should be changed based on present vehicle information; and
in response to determining that the trip limit for the load should be changed, updating the current profile by updating the trip current for the load.

7. The method of claim 6, wherein the vehicle information is collected directly from one or more sensors.

8. The method of claim 6, wherein the vehicle information is collected indirectly from one or more sensors via a communications network.

9. The method of claim 6, wherein the vehicle information comprises ambient temperature.

10. The method of claim 6, wherein the vehicle information comprises whether the vehicle is in an idle/power-off mode, vehicle speed, whether the vehicle is accelerating or decelerating, whether the vehicle is turning or moving straight, a charging state, a regeneration state, and/or an identification of a vehicle fault.

11. The method of claim 6, further comprising:
determining whether the vehicle is equipped with networking capability; and
in response to determining that the vehicle is equipped with networking capability, uploading the updated current profile to an external server.

12. The method of claim 6, further comprising:
determining whether an abnormality was detected; and
in response to determining that the abnormality was detected, logging the abnormality.

13. The method of claim 6, wherein the power management system comprises:
an input configured to receive current from a power source in the vehicle;
one or more outputs configured to couple with a respective one or more loads of the vehicle;
one or more switches associated with the respective one or more outputs, wherein each switch is configured to selectively open and close to selectively provide current received from the power source to that switch's associated output; and
circuitry configured to control the one or more of switches.

14. A vehicle power management system comprising:
an input configured to receive current from a power source in a vehicle;
one or more outputs configured to couple with a respective one or more loads of the vehicle;
one or more switches associated with the respective one or more outputs, wherein each switch is configured to selectively open and close to selectively provide current received from the power source to that switch's associated output; and
circuitry configured to:
measure a current draw of a load of the one or more loads;
collect vehicle information that exists when the current draw was measured;
using the collected vehicle information, determine a trip current for the load from a current profile for the load that specifies trip currents as a function of vehicle information;
determine if the measured current is greater than determined trip current;
in response to determining that the measured current is greater than determined trip current, disconnect the load.

15. The vehicle power management system of claim 14, further comprising one or more trip timers, one for each of the one or more outputs, wherein the circuitry is further configured to:
determine if one of the one or more trip timers has started.

16. The vehicle power management system of claim 15, wherein the circuitry is further configured to:
in response to determining that one of the one or more trip timers has not started, start one of the one or more trip timers, wherein a time for the one of the one or more trip timers is a function of the vehicle information.

17. The vehicle power management system of claim 15, wherein the circuitry is further configured to:
in response to determining that one of the one or more trip timers has started, determine whether a trip time has elapsed, wherein the load is disconnected in response to determining that the trip time has elapsed.

18. The vehicle power management system of claim 17, wherein the circuitry is further configured to:
in response to determining that the trip time has not elapsed, measure a current draw of another load of the one or more loads to determine if the another load should be disconnected.

19. The vehicle power management system of claim 17, wherein the circuitry is further configured to:
in response to determining that the measured current is not greater than determined trip current, reset a trip timer for the load.

20. The vehicle power management system of claim 19, wherein a trip time depend on measured current.

21. The vehicle power management system of claim 17, wherein the vehicle information comprises ambient temperature, whether the vehicle is in an idle/power-off mode, vehicle speed, whether the vehicle is accelerating or decelerating, whether the vehicle is turning or moving straight, and/or an identification of a vehicle fault.
